(19) United States
(12) Patent Application Publication
(10) Pub. No.: US 2025/0266584 A1
(43) Pub. Date: Aug. 21, 2025

(54) NOTCHING APPARATUS FOR SECONDARY BATTERIES

(71) Applicant: SK On Co., Ltd., Seoul (KR)

(72) Inventors: Joon Ho BAE, Daejeon (KR); Boung Sung KO, Daejeon (KR)

(21) Appl. No.: 19/051,171

(22) Filed: Feb. 12, 2025

(30) Foreign Application Priority Data
Feb. 16, 2024 (KR) 10-2024-0022758
Nov. 7, 2024 (KR) 10-2024-0157432

(51) Int. Cl. H01M 50/533

(52) U.S. Cl. CPC H01M 50/533

(57) ABSTRACT

Proposed is a notching apparatus for secondary batteries including a notching processing part provided on a transport path of an electrode film to create an electrode tab on the electrode film, a first variable roller positioned in front of the notching processing part based on a proceeding direction of the electrode film and provided to be movable, a first fixed roller fixedly placed near the first variable roller, a second variable roller positioned at a rear of the notching processing part based on the proceeding direction of the electrode film and provided to be movable, and a second fixed roller fixedly placed near the second variable roller.

### CROSS REFERENCE TO RELATED APPLICATION

The present application claims priority to Korean Patent Application No. 10-2024-0157432, filed Nov. 7, 2024, which claims priority to Korean Patent Application No. 10-2024-0022758 filed Feb. 16, 2024, the entire contents of which is incorporated herein for all purposes by this reference.

### BACKGROUND OF THE INVENTION

### Field of the Invention

The present disclosure relates to a notching apparatus for secondary batteries.

### Description of the Related Art

In general, a notching system is a facility to create an electrode tab by shearing a film for a secondary battery electrode. The system may consist of an unwinder part for unwinding a film for an electrode (hereinafter referred to as “electrode film”) wound in a roll shape, a notching processing part for shearing the electrode film into the form of an electrode tab, a vision inspection part for checking whether the processed electrode tab is processed normally, and a rewinder part for rewinding the processed electrode film into a roll shape.

A typical notching system may perform the electrode notching process by arranging the unwinder part, notching processing part, vision inspection part, and rewinder part inline and transporting an electrode film at a certain pitch. At this time, the electrode film may be advanced at a predetermined transport speed by the rewinder part rewinding the electrode film.

Meanwhile, notching is usually performed by shearing one electrode tab at a time. This method requires that the transport of the electrode film be temporarily stopped while notching is performed in the notching processing part, which can make the notching process take a long time.

Accordingly, a notching device for secondary batteries is required that can improve the productivity of secondary batteries by ensuring that the entire electrode film is transported without stopping even during notching processing.

In addition, a notching device for secondary batteries capable of simultaneously creating multiple electrode tabs during notching processing is required.

### Documents of Related Art

(Patent Document 0001) Korean Patent No. 10-1691937

### SUMMARY OF THE INVENTION

According to an aspect of the present disclosure, provided is a notching apparatus for secondary batteries that can improve productivity by ensuring that the transport of an electrode film is not interrupted during the notching process of the electrode film.

In addition, provided is a notching apparatus for secondary batteries capable of simultaneously creating multiple electrode tabs during notching processing.

According to another aspect of the present disclosure, provided is a notching apparatus for secondary batteries that can be widely applied to green technology fields such as electric vehicles, battery charging stations, and solar and wind power generation using batteries.

A notching apparatus for secondary batteries according to an embodiment of the present disclosure may include: a notching processing part provided on a transport path of an electrode film to create an electrode tab on the electrode film; a first variable roller positioned in front of the notching processing part based on a proceeding direction of the electrode film and provided to be movable; a first fixed roller fixedly placed near the first variable roller; a second variable roller positioned at the rear of the notching processing part based on the proceeding direction of the electrode film and provided to be movable; and a second fixed roller fixedly placed near the second variable roller.

In this case, the notching processing part may include an upper mold and a lower mold placed facing each other above and below the electrode film with the electrode film in between.

In addition, the notching processing part may simultaneously create multiple electrode tabs on the electrode film with a single shearing process.

In addition, the first variable roller and the second variable roller may be provided to be able to move both in a forward direction same as the proceeding direction of the electrode film and in a reverse direction opposite to the proceeding direction.

In addition, the first variable roller and the second variable roller may be provided to move the same distance in the same direction.

In addition, the movement distance of the first variable roller and the second variable roller may be set so that a portion where a next electrode tab is to be processed on the electrode film reaches a notching position in the notching processing part.

In addition, the first variable roller and the second variable roller may participate in a transport of the electrode film, and the electrode film may be provided to be wound around at least a portion of an outer periphery of the first variable roller and around at least a portion of an outer periphery of the second variable roller.

In this case, the first fixed roller may be placed ahead of the first variable roller based on the proceeding direction of the electrode film.

In addition, the second fixed roller may be placed behind the second variable roller based on the proceeding direction of the electrode film.

In this case, the first variable roller and the second variable roller may be independently moved by separately provided respective moving parts.

Each of the moving parts may include: a shaft part on which the first variable roller or the second variable roller is rotatably installed; a moving body connected to the shaft part and provided so that the first variable roller or the second variable roller may move; a power generation part provided to supply external force to the moving body; and a power transmission part provided to transmit external force of the power generation part to the moving body.

In addition, the power transmission part may include: a rotating body configured to rotate forward and reversely by the power generation part and have screw threads formed on an outer periphery thereof; and a conversion part configured to extend from the moving body toward the rotating body and be helically connected to the rotating body to convert a rotational motion of the rotating body into a reciprocating linear motion.

The features and advantages of the present disclosure will become more apparent from the following detailed description based on the accompanying drawings.

Prior to this, terms or words used in this specification and claims should not be construed in their usual, dictionary meaning, and must be interpreted with meaning and concept consistent with the technical idea of the present disclosure on the basis of the principle that the inventor can define terminology appropriately to explain his or her invention in the best way possible.

According to an embodiment of the present disclosure, even when notching an electrode film, the transport can be continued without interruption by means of a surplus electrode film, and thus the productivity of secondary batteries can be improved.

Furthermore, since multiple electrode tabs can be processed simultaneously during notching processing, the notching processing time can be shortened.

### BRIEF DESCRIPTION OF THE DRAWINGS

FIG. 1 is a side view schematically showing the configuration of a notching apparatus for secondary batteries according to an embodiment of the present disclosure.

FIG. 2 is an operational state view showing the state of notching processing by a notching processing part.

FIG. 3 is an operational state view showing a state in which electrode tabs are formed on an electrode film after notching processing.

FIG. 4 is an operational state view showing a state in which the electrode film is moved in the forward direction by a first variable roller and a second variable roller in the state of FIG. 3.

FIG. 5 is an operational state view showing a state in which a surplus electrode film is created as the first variable roller and the second variable roller return to their original positions in the state of FIG. 4.

FIG. 6 is a cross-sectional view schematically showing the mechanism of a moving part that moves the first variable roller or the second variable roller.

### DETAILED DESCRIPTION OF THE INVENTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments.

In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., used to distinguish one component from another component, and the components are not limited by the terms.

Hereinafter, an embodiment of the present disclosure will be described in detail with reference to the attached drawings.

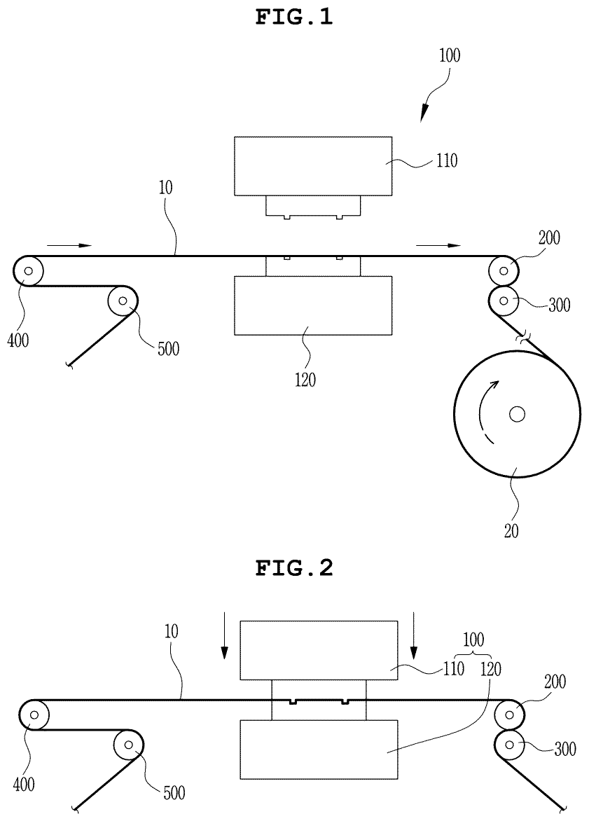

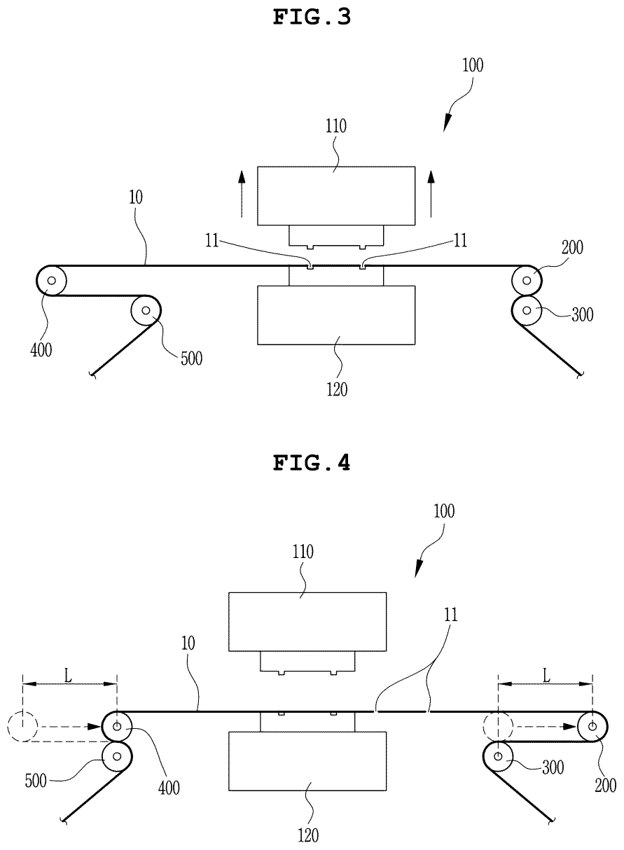

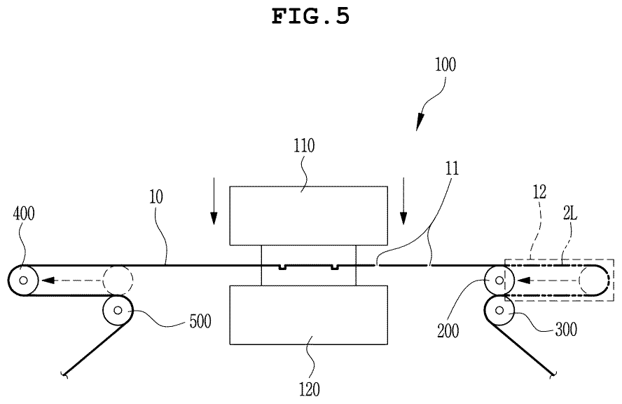

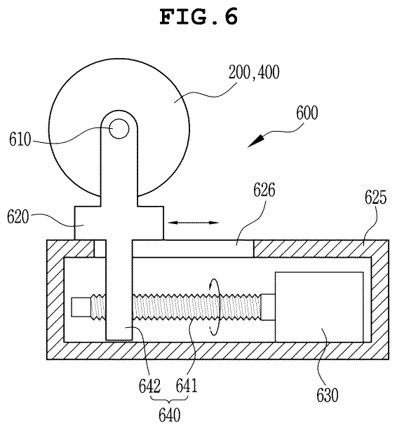

FIG. 1 is a side view schematically showing the configuration of a notching apparatus for secondary batteries according to an embodiment of the present disclosure; FIG. 2 is an operational state view showing the state of notching processing by a notching processing part; FIG. 3 is an operational state view showing a state in which electrode tabs are formed on an electrode film after notching processing; FIG. 4 is an operational state view showing a state in which the electrode film is moved in the forward direction by a first variable roller and a second variable roller in the state of FIG. 3; FIG. 5 is an operational state view showing a state in which a surplus electrode film is created as the first variable roller and the second variable roller return to their original positions in the state of FIG. 4; and FIG. 6 is a cross-sectional view schematically showing the mechanism of a moving part that moves the first variable roller or the second variable roller.

As shown in FIG. 1, a notching apparatus for secondary batteries according to an embodiment of the present disclosure may include: a notching processing part 100 provided on the transport path of an electrode film 10 to create an electrode tab 11 on the electrode film 10; a first variable roller 200 positioned in front of the notching processing part 100 based on the proceeding direction of the electrode film 10 and provided to be movable; a first fixed roller 300 fixedly placed near the first variable roller 200; a second variable roller 400 positioned at the rear of the notching processing part 100 based on the proceeding direction of the electrode film 10 and provided to be movable; and a second fixed roller 500 fixedly placed near the second variable roller 400.

The notching processing part 100 may be provided on the transport path of the electrode film 10 that proceeds along a preset path. At this time, the notching processing part 100 may shear a specific portion (e.g., a non-coated portion) of the electrode film 10 to create the electrode tab 11 on the electrode film 10.

In this case, the notching processing part 100 may include an upper mold 110 and a lower mold 120 placed facing each other above and below the electrode film 10 with the electrode film 10 in between.

Referring to FIG. 1, the upper mold 110 may be placed above the electrode film 10, and the lower mold 120 may be placed below the electrode film 10. Thus, the upper mold 110 and the lower mold 120 may be placed to face each other with the electrode film 10 interposed therebetween. In this case, a punch may be mounted on the upper mold 110, and a die may be mounted on the lower mold 120.

As shown in FIG. 2, to form the electrode tab 11 on the electrode film 10, at least one of the upper mold 110 and the lower mold 120 may be moved in the direction of shearing the electrode film 10.

Accordingly, the upper mold 110 may be lowered toward the lower mold 120, the lower mold 120 may be raised toward the upper mold 110, and it is also possible for both the upper mold 110 and the lower mold 120 to be lowered and raised. As the upper mold 110 and the lower mold 120 come into contact with each other, the electrode tab 11 may be formed on the electrode film 10 located between the upper mold 110 and the lower mold 120.

At this time, the notching processing part 100 may simultaneously form multiple electrode tabs 11 on the electrode film 10 with a single shearing process.

The notching processing part 100 according to the present disclosure may be configured so that multiple, i.e., two or more electrode tabs 11 are simultaneously formed on the electrode film 10 through a single shearing process.

That is, since a large number of electrode tabs 11 may be processed at one time through multi-notching, the time required for notching processing may be shortened. The attached drawing shows that the notching processing part 100 is able to notch two electrode tabs 11 at one time, but this is only an example, and it is also possible to configure the notching processing part 100 to process two or more electrode tabs 11 at the same time as needed.

Thus, as shown in FIG. 3, when at least one of the upper mold 110 and the lower mold 120 returns to the original position thereof so that the upper mold 110 and the lower mold 120 are spaced apart from each other with the electrode film 10 in between, the electrode tab 11 that has been sheared by the notching processing part 100 may be formed in a specific portion of the electrode film 10. One or more electrode tabs 11 may be created on the electrode film 10 in one shearing process depending on the type of notching processing part 100.

Meanwhile, the first variable roller 200 may be positioned in front of the notching processing part 100 based on the proceeding direction of the electrode film 10. Referring to FIG. 1, since the electrode film 10 proceeds from the left to the right in the drawing, the right side may be defined as the front and the left side may be defined as the rear based on the notching processing part 100.

The first variable roller 200 positioned in front of the notching processing part 100 may be rotated by the electrode film 10 that is being moved. In addition, the first variable roller 200 is not fixed in place, but may be provided to be movable within a preset section. The first variable roller 200 will be described again later.

The first fixed roller 300 is positioned in the proximity of the first variable roller 200, and may be rotated by the electrode film 10 that proceeds. In this case, unlike the first variable roller 200, the first fixed roller 300 may be fixed in place without moving.

The first fixed roller 300 may be placed at an appropriate position on the transport path of the electrode film 10 to transport the electrode film 10 along a preset path and to help the electrode film 10 advance smoothly.

The second variable roller 400 may be positioned at the rear of the notching processing part 100. The second variable roller 400 positioned at the rear of the notching processing part 100 may be rotated by the electrode film 10 that proceeds.

In addition, like the first variable roller 200, the second variable roller 400 is not fixed in place but may be provided to be movable within a preset range. The second variable roller 400 will be described again later.

The second fixed roller 500 is positioned in the proximity of the second variable roller 400, and may be rotated by the electrode film 10 that proceeds. In this case, unlike the second variable roller 400, the second fixed roller 500 may be fixed in place without moving. Like the first fixed roller 300, the second fixed roller 500 may be placed at an appropriate position on the transport path of the electrode film 10 to transport the electrode film 10 along a preset path and to help the electrode film 10 advance smoothly.

In this case, the first variable roller 200 and the second variable roller 400 may be provided so as to be able to move both in the forward direction same as the proceeding direction of the electrode film 10 and in the reverse direction opposite to the proceeding direction.

As shown in FIG. 4, once the electrode tab 11 is processed on the electrode film 10, the first variable roller 200 may be moved in the forward direction same as the proceeding direction of the electrode film 10, that is, in the right direction in the drawing, by a preset distance L.

At the same time as the movement of the first variable roller 200, the second variable roller 400 may also move in the forward direction same as the proceeding direction of the electrode film 10, that is, in the right direction in the drawing, by the same distance (preset distance L) as the first variable roller 200.

That is, the first variable roller 200, the second variable roller 400 may be provided to move the same distance in the same direction.

Accordingly, the electrode film 10 with the electrode tab 11 processed may be moved in the same direction as the proceeding direction of the electrode film 10 by the forward movement of the first variable roller 200 and the second variable roller 400.

At this time, the movement distance of the first variable roller 200 and the second variable roller 400 may be set so that the portion where the next electrode tab 11 is to be processed on the electrode film 10 reaches the notching position in the notching processing part 100.

That is, as shown in FIG. 4, after the electrode tab 11 is formed on the electrode film 10, the electrode film 10 moves in the forward direction by the forward movement of the first variable roller 200 and the second variable roller 400, and a predetermined portion where the next electrode tab 11 is to be processed on the electrode film 10 may reach the notching position in the notching processing part 100. As a result, the electrode film 10 waits for the next order of notching processing with the portion where the next electrode tab 11 is to be formed reaching the correct position for notching in the notching processing part 100, and through this series of processes, electrode tabs 11 having a constant pitch may be continuously processed on the electrode film 10.

Meanwhile, as shown in FIG. 5, when the notching processing part 100 punches the electrode film 10 to perform the next notching processing, the first variable roller 200 and the second variable roller 400 may move in the opposite direction to the proceeding direction of the electrode film 10, that is, in the left direction in the drawing, by a preset distance L. At this time, the distance (preset distance L) by which the first variable roller 200 and the second variable roller 400 move in the reverse direction may be the same as the distance by which the first variable roller 200 and the second variable roller 400 move in the forward direction.

However, as shown in FIG. 5, the first variable roller 200 and the second variable roller 400 move in the opposite direction to the proceeding direction of the electrode film 10 while both the upper mold 110 and the lower mold 120 are pressing the electrode film 10.

Thus, as the first variable roller 200 moves in the reverse direction a preset distance, based on the first variable roller 200, an extra electrode film (hereinafter referred to as “surplus electrode film 12”) is produced in front of the first variable roller 200 due to the reverse movement of the first variable roller 200. The total length of the surplus electrode film 12 may be a length 2L that is twice the movement distance L of the first variable roller 200.

For reference, the surplus electrode film 12 may be transported through the first fixed roller 300 toward a rewinder part 20 where the electrode film 10 is rewound, and although the electrode film 10 temporarily stops moving at the moment the notching processing part 100 notches the electrode film 10, as the surplus electrode film 12 may continue to be transported toward the rewinder part 20, the overall transport of the electrode film 10 may be considered to continue without stopping.

In addition, when the second variable roller 400 moves in the reverse direction by the preset distance L like the first variable roller 200, since the electrode film 10 in front of the second variable roller 400 is pressed by the upper mold 110 and the lower mold 120 and is thus stationary and unable to move, the electrode film 10 supplied from an unwinder part (not shown) may be additionally supplied with a length 2L corresponding to twice the reverse movement distance L of the second variable roller 400.

In this case, the first variable roller 200 and the second variable roller 400 participate in the transport of the electrode film 10, and the electrode film 10 may be provided to be wound around at least a portion of the outer periphery of the first variable roller 200 and around at least a portion of the outer periphery of the second variable roller 400.

That is, the electrode film 10 may proceed in a zigzag manner along a transport path while wrapping at least a portion of the outer periphery of the first variable roller 200 and passing through the first fixed roller 300. In addition, the electrode film 10 may proceed in a zigzag manner along a transport path while passing through the second fixed roller 500 and wrapping at least a portion of the outer periphery of the second variable roller 400.

At this time, the first fixed roller 300 may be placed ahead of the first variable roller 200 based on the proceeding direction of the electrode film.

That is, the first fixed roller 300 should be positioned so as to contact the electrode film located ahead of the first variable roller 200 with respect to the proceeding direction of the electrode film 10, so that the surplus electrode film 12 may be produced due to the positional movement of the first variable roller 200.

In addition, the second fixed roller 500 may be placed behind the second variable roller 400 based on the proceeding direction of the electrode film.

The second fixed roller 500 should be positioned so as to contact the electrode film located behind the second variable roller 400 with respect to the proceeding direction of the electrode film 10, so that the electrode film 10 may be additionally supplied due to the positional movement of the second variable roller 400.

In this way, as the first variable roller 200 and the second variable roller 400 move in the forward direction and then move in the reverse direction, the electrode film 10 between the front of the first variable roller 200 and the first fixed roller 300 may become the surplus electrode film 12. In addition, by the movement of the second variable roller 400, the electrode film 10 may be pulled to a length corresponding to the length of the surplus electrode film 12 and additionally supplied. Accordingly, even though the proceeding of the electrode film 10 is temporarily stopped at the notching processing part 100 during shear processing, the overall transport of the electrode film 10 may be considered to continue without stopping.

Therefore, the rewinder part 20 may continuously rewind the electrode film 10 even when the notching processing part 100 processes the electrode tab 11, so that the overall productivity of the electrode film 10 may be improved.

Meanwhile, the first variable roller 200 and the second variable roller 400, which are provided to be movable in the forward and reverse directions, may be independently moved by separately provided respective moving parts 600.

As shown in FIG. 6, the moving part 600 may be provided separately for each of the first variable roller 200 and the second variable roller 400. The moving part 600 provided for the first variable roller 200 and the moving part 600 provided for the second variable roller 400 have the same configuration, structure, and operating mechanism, and thus both moving parts 600 are described using the same reference numerals.

To be specific, the moving part 600 may include: a shaft part 610 on which the first variable roller 200 or the second variable roller 400 is rotatably installed; a moving body 620 connected to the shaft part 610 and provided so that the first variable roller 200 or the second variable roller 400 may move; a power generation part 630 provided to supply external force to the moving body 620; and a power transmission part 640 provided to transmit external force of the power generation part 630 to the moving body 620.

The shaft part 610 is configured to be the center of rotation of the first variable roller 200 or the second variable roller 400, and the first variable roller 200 or the second variable roller 400 may be installed on the shaft part 610 so as to be rotatable.

The moving body 620 is connected to the shaft part 610, and may enable the first variable roller 200 or the second variable roller 400 installed on the shaft part 610 to move in the forward and reverse directions. At this time, the moving body 620 may be installed in a housing part 625 that guides the movement of the moving body 620 and sets a movement section so that the moving body 620 moves within a preset distance.

A predetermined receiving space may be formed inside the housing part 625, and the first variable roller 200, the shaft part 610, and the moving body 620 may be positioned so as to be exposed on the outside of the housing part 625. A slot part 626 that guides the movement of the moving body 620 and limits the movement section may be formed in the housing part 625.

The power generation part 630 is configured to supply external force to the moving body 620, and may be installed in the receiving space of the housing part 625. The power generation part 630 is not particularly limited in type as long as the power generation part 630 can generate power and supply the power to the moving body 620. The power generation part 630 may be a motor capable of both forward and reverse rotation, a servo motor, etc., and other power sources may also be used.

The power transmission part 640 may be configured to transmit external force of the power generation part 630 to the moving body 620. The power transmission part 640 may transmit external force provided from the power generation part 630 to the moving body 620 so that the moving body 620 may move in the forward and reverse directions. The power transmission part 640 may be configured to convert the rotational force provided from the power generation part 630 into a reciprocating linear motion and provide the converted force to the moving body 620.

To be specific, the power transmission part 640 may include: a rotating body 641 that rotates forward and reversely by the power generation part 630 and has screw threads formed on the outer periphery thereof; and a conversion part 642 that extends from the moving body 620 toward the rotating body 641 and is helically connected to the rotating body 641 to convert the rotational motion of the rotating body 641 into a reciprocating linear motion.

The rotating body 641 may be a rotary shaft of the power generation part 630, and may rotate in the same direction when the power generation part 630 rotates forward or backward. Screw threads may be formed on the outer periphery of the rotating body 641.

The conversion part 642 is configured to be connected to the moving body 620 and to extend from the moving body 620 toward the rotating body 641. One end of the conversion part 642 is connected to the moving body 620, and the other end of the conversion part 642 may be coupled to the rotating body 641.

The other end of the conversion part 642 is helically connected to the rotating body 641 and may move linearly along the longitudinal direction of the rotating body 641 when the rotating body 641 rotates. The conversion part 642 may change the direction of linear motion depending on the rotational direction of the rotating body 641 and may move reciprocally linearly. As the conversion part 642 moves in a reciprocating linear motion, the moving body 620 connected to the conversion part 642 may also move in a reciprocating linear motion in the same direction, and accordingly, the first variable roller 200 or the second variable roller 400 may also move in a reciprocating linear motion in the same direction. In this case, the spiral coupling and movement structure of the rotating body 641 and the conversion part 642 may be similar to, for example, a linear motion (LM) guide, and an LM guide may be used as needed.

Above, the present disclosure has been described in detail through specific embodiments. The embodiments are for specifically explaining the present disclosure, and the present disclosure is not limited thereto. It is obvious to those skilled in the art that various changes and modifications to the embodiments are possible within the scope and spirit of the present disclosure, and it is also obvious that such changes and modifications fall within the scope of the appended patent claims.

What is claimed is:

1. A notching apparatus for secondary batteries, the apparatus comprising:
a notching processing part provided on a transport path of an electrode film to create an electrode tab on the electrode film;
a first variable roller positioned in front of the notching processing part based on a proceeding direction of the electrode film and provided to be movable;
a first fixed roller fixedly placed near the first variable roller;
a second variable roller positioned at a rear of the notching processing part based on the proceeding direction of the electrode film and provided to be movable; and
a second fixed roller fixedly placed near the second variable roller.

2. The apparatus of claim 1, wherein the notching processing part comprises an upper mold and a lower mold placed facing each other above and below the electrode film with the electrode film in between.

3. The apparatus of claim 1, wherein the notching processing part simultaneously creates multiple electrode tabs on the electrode film with a single shearing process.

4. The apparatus of claim 1, wherein the first variable roller and the second variable roller are provided to be able to move both in a forward direction same as the proceeding direction of the electrode film and in a reverse direction opposite to the proceeding direction.

5. The apparatus of claim 4, wherein the first variable roller and the second variable roller are provided to move a same distance in a same direction.

6. The apparatus of claim 5, wherein a movement distance of the first variable roller and the second variable roller is set so that a portion where a next electrode tab is to be processed on the electrode film reaches a notching position in the notching processing part.

7. The apparatus of claim 1, wherein the first variable roller and the second variable roller participate in a transport of the electrode film, and the electrode film is provided to be wound around at least a portion of an outer periphery of the first variable roller and around at least a portion of an outer periphery of the second variable roller.

8. The apparatus of claim 1, wherein the first fixed roller is placed ahead of the first variable roller based on the proceeding direction of the electrode film.

9. The apparatus of claim 1, wherein the second fixed roller is placed behind the second variable roller based on the proceeding direction of the electrode film.

10. The apparatus of claim 1, wherein the first variable roller and the second variable roller are independently moved by separately provided respective moving parts.

11. The apparatus of claim 10, wherein each of the moving parts comprises:
a shaft part on which the first variable roller or the second variable roller is rotatably installed;
a moving body connected to the shaft part and provided so that the first variable roller or the second variable roller may move;
a power generation part provided to supply external force to the moving body; and
a power transmission part provided to transmit external force of the power generation part to the moving body.

12. The apparatus of claim 11, wherein the power transmission part comprises:
a rotating body configured to rotate forward and reversely by the power generation part and have screw threads formed on an outer periphery thereof; and
a conversion part configured to extend from the moving body toward the rotating body and be helically connected to the rotating body to convert a rotational motion of the rotating body into a reciprocating linear motion.
